(19) United States
(12) Patent Application Publication
(10) Pub. No.: US 2007/0128430 A1
(43) Pub. Date: Jun. 7, 2007

(54) Retardation layer forming coating solution, retardation optical product, and manufacturing method of retardation optical product

(76) Inventors: Kenji Shirai, Tokyo (JP); Keiji Kashima, Tokyo (JP)

Correspondence Address: LADAS & PARRY LLP, 224 SOUTH MICHIGAN AVENUE, SUITE 1600, CHICAGO, IL, 60604, US

(21) Appl. No.: 11/527,978

(22) Filed: Sep. 27, 2006

(30) Foreign Application Priority Data
Sep. 30, 2005 (JP) 2005-286373

(51) Int. Cl. B32B 27/18; B05D 5/06

(52) U.S. Cl. 428/323; 427/162

(57) ABSTRACT

A main object of the present invention is to provide a retardation layer forming coating solution capable of forming a retardation layer showing the property as the optically negative C plate on an optional substrate. To achieve the object, the invention provides a retardation layer forming coating solution used for forming a retardation layer showing the property as the optically negative C plate, comprising a resin having the optical isotropy, a rodlike compound having the refractive index anisotropy, and a solvent for dissolving the resin and the rodlike compound.

### BACKGROUND OF THE INVENTION

1. Field of the Invention

The present invention relates to a retardation layer forming coating solution used for forming a retardation layer of a retardation optical product used in for example a liquid crystal displays. More specifically, it relates to a retardation layer forming coating solution capable of forming a retardation layer having the property as an optically negative C plate by being applied onto an optional substrate.

2. Description of the Related Art

Owing to the characteristics of such as power saving, lightweight and thin shape, the liquid crystal displays have recently been spread at a high rate instead of the conventional CRT displays. As a common liquid crystal displays, one comprising an incident side polarizing plate 102A, an output side polarizing plate 102B and a liquid crystal cell 104 as shown in FIG. 3 can be presented. The polarizing plates 102A and 102B are provided for selectively transmitting only a linear polarization (shown schematically by the arrow in the figure) having an oscillation plane in a predetermined oscillation direction, disposed in a crossed Nicol state with their oscillation directions perpendicular with each other. Moreover, the liquid crystal cell 104 including a large number of cells corresponding to the pixels is disposed between the polarizing plates 102A and 102B.

As the liquid crystal displays, those of various systems have been put into practice according to the alignment form of the liquid crystal molecules comprising the liquid crystal cell. Recently, those of the VA (vertical alignment) system are the mainstream. The liquid crystal displays of the VA system are widely used mainly for the liquid crystal televisions.

As to the liquid crystal cells used for the above-mentioned liquid crystal displays of the VA system, since the liquid crystal molecules are aligned vertically, the liquid crystal cells as a whole has the optical characteristics to function as a positive C plate. For example, if the liquid crystal cell 104 of the liquid crystal display 100 shown in FIG. 3 has such optical characteristics, a linear polarization transmitted the incident side polarizing plate 102A passes through a cell portion in the non driven state out of the liquid crystal cell 104 without the phase shift so as to be blocked by the output side polarizing plate 102B. On the other hand, at the time of passing through a cell portion in the driven state out of the liquid crystal cell 104, the linear polarization has the phase shift so that a light beam according to the phase shift amount is transmitted and outputted from the output side polarizing plate 102B. Therefore, by optionally controlling the driving voltage of the liquid crystal cell 104 per cell, a desired image can be displayed on the output side polarizing plate 102B side. The liquid crystal display 100 is not limited to those having the light transmission and shielding embodiment mentioned above. A liquid crystal display provided such that a light beam outputted from a cell portion in the non drive state out of the liquid crystal cell 104 is outputted after transmitting through the output side polarizing plate 102B and a light beam outputted from a cell portion in the driven state is shielded by the output side polarizing plate 102B is also proposed.

Considering the case with a linear polarization transmitting a cell portion in the non driven state out of the VA system liquid crystal cell 104 mentioned above, since the liquid crystal cell 104 has the optical characteristics to function as a positive C plate, although a light beam inputted along the normal line of the liquid crystal cell 104 out of the linear polarization transmitted the incident side polarizing plate 102A is transmitted without the phase shift, a light beam incident in the direction inclined with respect to the normal line of the liquid crystal cell 104 out of the linear polarization transmitted the incident side polarizing plate 102A becomes an elliptical polarization due to the retardation generated at the time of transmitting the liquid crystal cell 104. The size of the retardation generated to the light beam transmitted the liquid crystal cell 104 (transmitted light beam) is influenced also by such as the birefringence value of the liquid crystal molecules sealed inside the liquid crystal cell 104, the liquid crystal cell 104 thickness, or the wavelength of the transmitted light beam.

Due to the above-mentioned phenomena, even in the case with a cell in the liquid crystal cell 104 is in the non driven state and a linear polarization should be transmitted as it is so as to be shielded by the output side polarizing plate 102B, a part of the light beam outputted in the direction inclined with respect to the normal line of the liquid crystal cell 104 is leaked from the output side polarizing plate 102B. Therefore, according to the conventional liquid crystal display 100 as mentioned above, a problem of the deterioration of the display quality of an image observed from the direction inclined with respect to the normal line of the liquid crystal cell 104 compared with an image observed from the front side (viewing angle dependency problem) has been present.

In order to improve the problem of the viewing angle dependency in the liquid crystal display, various techniques have been developed so far. As a representative method, a method of using a retardation film having a predetermined birefringence index can be presented. Such a method for improving the viewing angle dependency problem using a retardation film is advantageous in that the viewing angle dependency problem of the liquid crystal display apparatus using a liquid crystal cell having various optical characteristics can be improved by changing the birefringence index of the retardation film according to the kind of the liquid crystal cell. In particular, as a method for improving the viewing angle dependency of the liquid crystal display having the VA system, a method of offsetting the property as the optically positive C plate of the VA system liquid crystal cell by using a retardation film having the property as the optically negative C plate is used widely as a method for easily improving the viewing angle dependency problem.

As the retardation film having the above-mentioned property as the optically negative C plate, for example, a retardation film having a retardation layer having a molecule structure of a cholesteric regularity (retardation layer showing a birefringence) formed on a substrate having an alignment layer as disclosed in Japanese Patent Application Laid-Open (JP-A) Nos. 3-67219 and 4-322223, and a retardation film having a retardation layer made of a disc like compound (retardation layer sowing the birefringence) formed on a substrate having an alignment layer as disclosed in JP-A No. 10-312166 are widely used.

Under such circumstances, recently, as the retardation films used for the improvement of the viewing angle dependency of the liquid crystal displays, those having a plurality of optical properties are required instead of those having a single optical property. For example, as to the liquid crystal displays employing the VA system liquid crystal cell, those having the property as the optically negative C plate and the property as the optically A plate in combination are required. However, as mentioned above, since the conventional retardation films having the property as the optically negative C plate realize the property as the optically negative C plate by regularly arranging the liquid crystalline compound having the cholesteric regularity or the disc like compound, an alignment layer for regularly arranging the above-mentioned liquid crystalline compound and disc like compound has been essential. Therefore, a retardation layer showing the property as the optically negative C plate cannot be formed on a substrate incapable of forming an alignment layer. Accordingly, there is a problem that a retardation film having a plurality of optical properties cannot be formed optionally due to the limitation in kinds of the usable substrates in the conventional retardation films.

### SUMMARY OF THE INVENTION

The present invention has been achieved in view of the above-mentioned problems, and a main object thereof is to provide a retardation layer forming coating solution capable of forming a retardation layer showing the property as the optically negative C plate on an optional substrate.

To solve the above-mentioned problems, the present invention provides a retardation layer forming coating solution used for forming a retardation layer showing the property as the optically negative C plate, comprising a resin having the optical isotropy, a rodlike compound having the refractive index anisotropy, and a solvent for dissolving the resin and the rodlike compound.

According to the retardation layer forming coating solution of the present invention, since the above-mentioned resin is distributed randomly at the time of being coated on an optional substrate, the above-mentioned rodlike compound can form a sequence state capable of realizing the property as the optically negative C plate. Therefore, according to the retardation layer forming coating solution of the present invention, even in the case of being applied onto a substrate not having an alignment film for arranging the rodlike compound, a sequence state for realizing the property as the optically negative C plate can be formed by the rodlike compound. Therefore, according to the present invention, a retardation layer having the property as the optically negative C plate can be formed on an optional substrate.

In the above-mentioned invention, it is preferable that the content of the above-mentioned rodlike compound is in the range of 10 parts by weight to 200 parts by weight with respect to 100 parts by weight of the above-mentioned resin. Since the content of the rodlike compound is in the above-mentioned range, the transparency of the retardation layer to be formed using the retardation layer forming coating solution of the present invention can be improved.

Moreover, in the above-mentioned invention, it is preferable that the above-mentioned rodlike compound has a polymerizable functional group. Since the rodlike compound has a polymerizable functional group, the mechanical strength of the retardation layer to be formed using the retardation layer forming coating solution of the present invention can be improved.

Moreover, in the above-mentioned invention, it is preferable that the above-mentioned rodlike compound is a liquid crystalline material. Since the rodlike compound is a liquid crystalline material, the retardation layer to be formed using the retardation layer forming coating solution of the present invention can realize the excellent optical characteristic property per unit thickness.

Furthermore, in the above-mentioned invention, it is preferable that the above-mentioned resin is triacetyl cellulose. Since the resin is triacetyl cellulose, the sequence state of realizing the property as the optically negative C plate by the rodlike compound can easily be formed.

The present invention provides a retardation optical product comprising an optical substrate and a retardation layer formed on the optical substrate, wherein the retardation layer includes a resin having an optical isotropy and a rodlike compound having a refractive index anisotropy, and shows the property as an optically negative C plate.

According to the present invention, since the above-mentioned retardation layer includes a resin having an optical isotropy and a rodlike compound having a refractive index anisotropy, and it shows the property as the optically negative C plate, a retardation optical product having the property as the optically negative C plate can be obtained regardless of the kind of the above-mentioned optical substrate. Moreover, since the retardation layer includes the resin, a retardation optical product having the excellent adhesion property between the substrate and the retardation layer can be obtained.

In the above-mentioned invention, it is preferable that the content of the above-mentioned rodlike compound in the above-mentioned retardation layer is in the range of 10 parts by weight to 200 parts by weight with respect to 100 parts by weight of the above-mentioned resin. Since the content of the rodlike compound is in the above-mentioned range, the transparency of the above-mentioned retardation layer can be improved.

Moreover, in the above-mentioned invention, it is preferable that the above-mentioned retardation layer does not have a selective reflection wavelength. Since the retardation layer does not have a selective reflection wavelength, for example in the case of using a retardation optical product of the present invention as a viewing angle compensator for a liquid crystal display, deterioration of the display quality derived from the selective reflection of the retardation layer can be prevented.

Moreover, in the above-mentioned invention, it is preferable that a hard coat layer is provided between the above-mentioned optical substrate and the above-mentioned retardation layer. Since the hard coat layer is provided between the optical substrate and the retardation layer, a retardation optical product with little haze can be produced regardless of the kind of the optical substrate used in the present invention.

Furthermore, in the above-mentioned invention, it is preferable that the optical substrate has the property as the optically A plate. Since the above-mentioned optical substrate has the property as the optically A plate, the retardation optical product of the present invention can be provided with the property as the optically negative C plate and the property as the A plate.

The present invention provides a manufacturing method of a retardation optical product comprising a retardation layer forming step of forming a retardation layer showing the property as the optically negative C plate on an optical substrate by applying a retardation layer forming coating solution, wherein this retardation layer forming coating solution is the above-mentioned retardation layer forming coating solution according to the present invention.

According to the present invention, since the retardation layer forming coating solution is the retardation layer forming coating solution of the present invention, a retardation optical product having the property as the optically negative C plate can be produced regardless of the kind of the above-mentioned optical substrate.

The retardation layer forming coating solution of the present invention achieves the effect of forming a retardation layer showing the property as the optically negative C plate on an optional optical substrate.

### BRIEF DESCRIPTION OF THE DRAWINGS

FIG. 1 is a schematic perspective view showing an example of a retardation optical product of the present invention;

FIGS. 2A to 2C are each a schematic cross-sectional view showing an example of the using embodiment for a retardation optical product of the present invention; and

FIG. 3 is a schematic view showing an example of a common liquid crystal display.

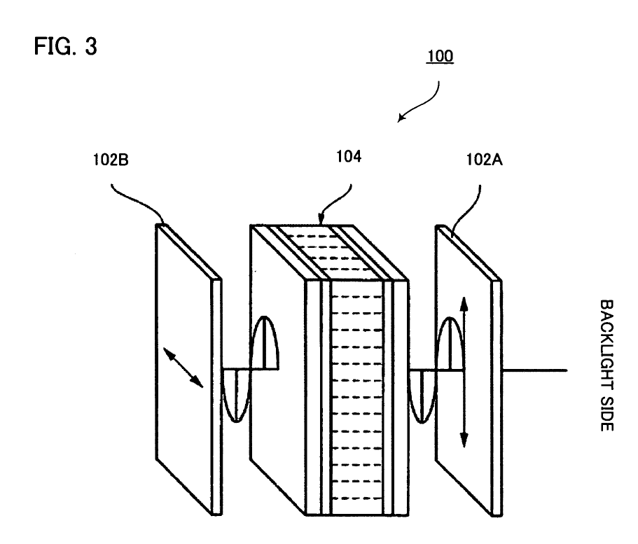

### DESCRIPTION OF THE PREFERRED EMBODIMENT

Hereinafter, the retardation layer forming coating solution, the retardation optical product, and the manufacturing method of a retardation optical product of the present invention will be explained in detail.

A. Retardation Layer Forming Coating Solution

First, the retardation layer forming coating solution of the present invention will be explained. The retardation layer forming coating solution of the invention is used for forming a retardation layer showing the property as the optically negative C plate (hereinafter, may referred to as the “minus C property”), including a resin having the optical isotropy, a rodlike compound having the refractive index anisotropy, and a solvent for dissolving the resin and the rodlike compound.

The retardation layer forming coating solution of the present invention includes a resin having the optical isotropic property and a rodlike compound having the refractive index anisotropy. According to the characteristic, a retardation layer having the minus C property can be formed on an optional substrate. Although the reason why a retardation layer having the minus C property can be formed on an optional substrate by including a resin having the optical isotropic property and a rodlike compound having the refractive index anisotropy in the retardation layer forming coating solution of the present invention is not clear, it is considered to be for the following reason. That is, in the case a retardation layer is formed by coating a retardation layer forming coating solution of the present invention on an optional substrate, as to the sequence state of the above-mentioned resin in the formed retardation layer, it is considered to be distributed randomly in the plane direction of the retardation layer, and it is arranged in the direction parallel to the plane direction of the retardation layer in the retardation layer thickness direction so as to form the so-called in-plane alignment. Moreover, since the above-mentioned rodlike compound having the refractive index anisotropy is “rodlike”, it has the anisotropy in the molecule shape so that the longer axis direction of the molecule shape is considered to have the tendency of being arranged along the sequence direction of the above-mentioned resin.

Therefore, in the case of forming a retardation layer using the retardation layer forming coating solution of the present invention, it is considered that a retardation layer having the minus C property can be formed by arranging the above-mentioned rodlike compound along the above-mentioned resin arranged as mentioned above in the formed retardation layer.

The retardation films conventionally used for such as an optical compensator for liquid crystal displays have realized a desired optical characteristic by regularly arranging a rodlike compound represented by the liquid crystalline material, or a disc like compound in the retardation layer. Therefore, in the conventional retardation films, for regularly arranging the above-mentioned rodlike compound or disc like compound, alignment layers having the alignment ability to these compounds have been essential. Thereby, for example, there is a problem that a retardation layer realizing a desired optical characteristic cannot be formed on a substrate incapable of forming the above-mentioned alignment layer.

According to the retardation layer forming coating solution of the present invention, since the above-mentioned resin having the optical isotropic property is considered to have the function of arranging the above-mentioned rodlike compound having the refractive index anisotropy, a retardation layer of a mode with the alignment layer and the retardation layer provided integrally can be formed. Therefore, according to the retardation layer forming coating solution of the present invention, a retardation layer showing the minus C property can be formed on an optional substrate.

Here, in the present invention, “to have the property as the optically negative C plate (minus C property)” mentioned above denotes that the retardation in the thickness direction of the retardation layer formed using the retardation layer forming coating solution of the present invention (hereinafter, it may be referred to as “Rth”) is 10 nm or more. The Rth is the value represented by the formula of Rth={(Nx+Ny)/2−Nz}×dth, with the refractive index Nx in the leading phase axis direction (the direction with the smallest refractive index) in the plane of the retardation layer, the refractive index Ny in the lagging phase axis direction (the direction with the largest refractive index), the refractive index Nz in the thickness direction and the thickness “d” of the retardation film. Rth used in the present invention uses an absolute value of Rth represented by the above equation. Rth in the present invention denotes the value at a 589 nm wavelength unless otherwise specified.

The retardation layer forming coating solution of the present invention includes a resin having the optical isotropy, a rodlike compound having the refractive index anisotropy and a solvent for dissolving the resin and the rodlike compound. Hereinafter, each configuration of the retardation layer forming coating solution of the present invention will be explained in detail.

1. Rodlike Compound Having the Refractive Index Anisotropy

First, the rodlike compound having the refractive index anisotropy used in the present invention (hereinafter, it may be simply referred to as the “rodlike compound”.) will be explained. In the present invention, “to have the refractive index anisotropy” mentioned above denotes to show the birefringence index by the difference of the refractive index in the longer axis direction and the shorter axis direction of the molecule shape of the rodlike compound. Moreover, the “rodlike compound” mentioned above denotes a compound having a rodlike principal skeleton.

The content of the rodlike compound in the retardation layer forming coating solution of the present invention is not particularly limited as long as it is in the range capable of forming a retardation layer for realizing a desired minus C property using the retardation layer forming coating solution of the present invention. In particular, in the present invention, it is preferable that the content of the rodlike compound is in the range of 10 parts by weight to 200 parts by weight with respect to 100 parts by weight of the resin having the optical isotropy to be described later; it is more preferably in the range of 30 parts by weight to 170 parts by weight; and it is particularly preferably in the range of 30 parts by weight to 150 parts by weight. In the case the content of the rodlike compound is less than the above-mentioned range, a retardation layer having a desired minus C property may not be formed using the retardation layer forming coating solution of the present invention. Moreover, in the case it is more than the above-mentioned range, depending on the kind of the rodlike compound, the mechanical strength of the retardation layer formed using the retardation layer forming coating solution of the present invention may not be provided in a predetermined range.

The rodlike compound used in the present invention is not particularly limited as long as it is a compound having a rodlike principal skeleton and the above-mentioned birefringence index. In particular, in the present invention, a compound having a relatively small molecular weight can preferably be used. Specifically, a compound having the molecular weight in the range of 200 to 1,200, in particular, in the range of 400 to 800 can be used preferably. Since the molecular weight is in the above-mentioned range, for example, in the case of forming a retardation layer on an optional substrate using the retardation layer forming coating solution of the present invention, it can easily be fit into the resin structure so as to easily realize the retardation property.

As to the above-mentioned molecular weight concerning the rodlike compound being a material having a polymerizable functional group to be described later, it refers to the molecular weight before the polymerization.

Moreover, it is preferable that the rodlike compound used in the present invention is a liquid crystalline material showing the liquid crystalline property. Since the rodlike compound is a liquid crystalline material, the above-mentioned retardation layer formed using the retardation layer forming coating solution of the present invention can be provided with the excellent optical characteristic realizing property per unit thickness. Moreover, it is preferable that the rodlike compound used in the present invention is a liquid crystalline material showing the nematic phase among the liquid crystalline materials. A liquid crystalline material showing the nematic phase can be aligned relatively easily.

Furthermore, it is preferable that the above-mentioned liquid crystalline material showing the nematic phase is a molecule having a spacer on both ends of the mesogen. Since a liquid crystalline material having a spacer on both ends of the mesogen has the excellent flexibility, clouding of the retardation layer in the present invention can effectively be prevented.

As the rodlike compound used in the present invention, those having a polymerizable functional group in a molecule can be used preferably. In particular, those having a three-dimensionally cross-linkable polymerizable functional group are preferable. Since the rodlike compound has a polymerizable functional group, the rodlike compound can be cured by the polymerization so that the mechanical strength of the retardation layer formed using the retardation layer forming coating solution of the present invention can be improved. In the present invention, the above-mentioned rodlike compound having a polymerizable functional group and the above-mentioned rodlike compound not having a polymerizable functional group can be used as a mixture.

The “three-dimensional cross-linking” mentioned above denotes to three-dimensionally polymerize the liquid crystalline molecules with each other so as to be in a mesh-like (network) structure state.

As the above-mentioned polymerizable functional group, various polymerizable functional groups to be polymerized by the function of the ionizing radiation such as the ultraviolet ray and the electron beam, or the heat can be used. As the representative examples of these polymerizable functional groups, a radically polymerizable functional group, or a cation polymerizable functional group can be presented. Furthermore, as the representative examples of the radically polymerizable functional group, a functional group having at least one addition polymerizable ethylenically unsaturated double bond can be presented. As the specific examples, a vinyl group having or not having a substituent, or an acrylate group (the general term including an acryloyl group, a methacryloyl group, an acryloyloxy group, and a methacryloyloxy group) can be presented. Moreover, as the specific examples of the cation polymerizable functional group, an epoxy group, or the like can be presented. Additionally, as the polymerizable functional group, for example, an isocyanate group, an unsaturated triple bond, or the like can be presented. Among these examples, in terms of the process, a functional group having an ethylenically unsaturated double bond can be used preferably.

As the rodlike compound in the present invention, a liquid crystalline material showing the liquid crystalline property, having the above-mentioned polymerizable functional group on the end is particularly preferable. For example, by using a nematic liquid crystalline material having a polymerizable functional group on the both ends, a mesh-like (network) structure state can be provided by the three-dimensional polymerization with each other so as to obtain a retardation layer having the sequence stability and the excellent optical characteristic realizing property. Moreover, even in the case of one having a polymerizable functional group on one end, it can have the sequence stability by cross-linking with the other molecules. As such a rodlike compound, the compounds represented by the following formulae (1) to (6) can be presented.

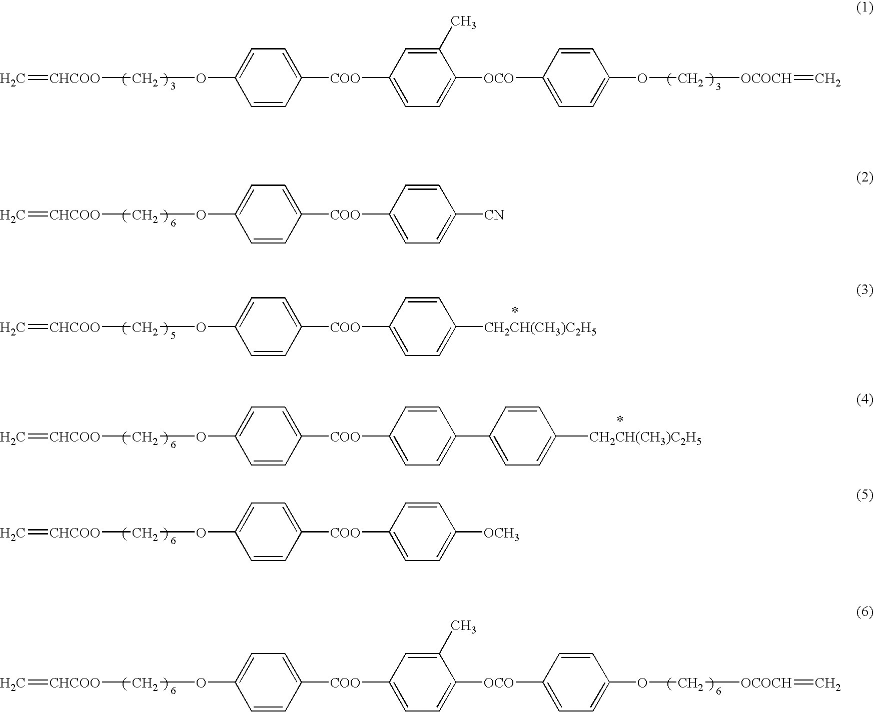

Here, the liquid crystalline materials represented by the chemical formulae (1), (2), (5) and (6) can be prepared according to the methods disclosed by D. J. Broer et, al., Makromol. Chem. 190, 3201-3215 (1989), or by D. J. Broer et, al., Makromol. Chem. 190, 2250 (1989), or by a similar method. Moreover, preparation of the liquid crystalline materials represented by the chemical formulae (3) and (4) is disclosed in DE 195,04,224.

Moreover, as the specific examples of the nematic liquid crystalline material having an acrylate group on the end, those represented by the following chemical formulae (7) to (17) can also be presented.

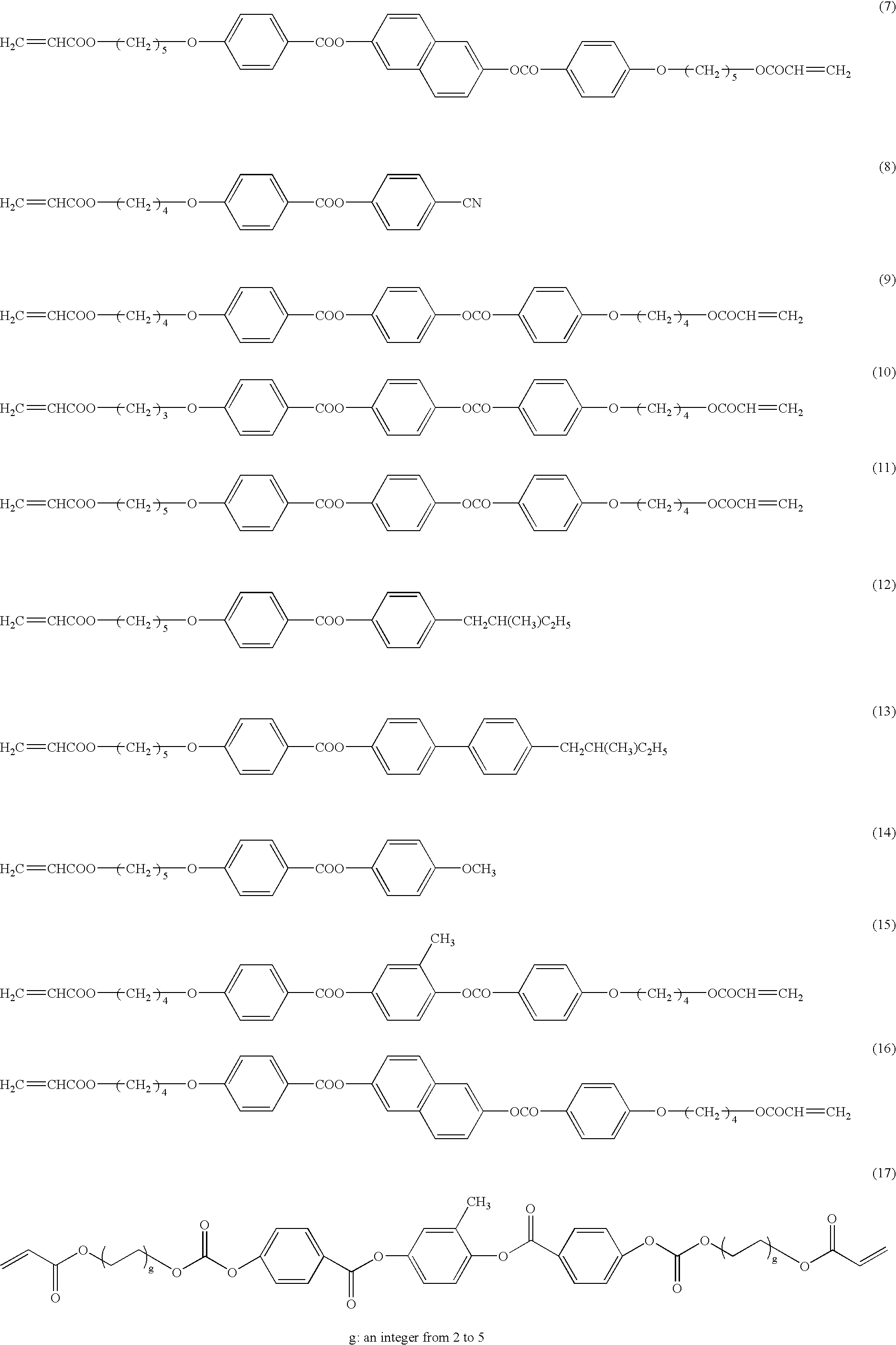

In the present invention, as the rodlike compound, only one kind may be used, or two or more kinds may be used as a mixture. As an embodiment of using two or more kinds as a mixture, for example, an embodiment of using a mixture of a liquid crystalline material having one or more polymerizable functional groups on the both ends and a liquid crystalline material having one or more polymerizable functional groups on one end can be presented. Since the polymerization density (cross-linking density) and the optical characteristics can be adjusted optionally by adjustment of the composition ratio thereof, the embodiment is preferable.

2. Resin Having the Optical Isotropy

Next, the resin having the optical isotropy used in the present invention (hereinafter, it may simply be referred to as the “resin”.) will be explained. The resin used in the present invention has the optical isotropy.

The resin used in the present invention is not particularly limited as long as it has the optical isotropy so that it may be determined optionally in consideration to the adhesion property with respect to the substrate for forming the retardation layer using the retardation layer forming coating solution of the present invention, or the like. Moreover, the resin used in the present invention may be used by only one kind or as a mixture of two or more kinds.

In the present invention, it is preferable to use a cellulose derivative as the resin because the cellulose derivative has the excellent optical isotropic property. As the cellulose derivative used in the present invention, cellulose esters can be used preferably. Furthermore, among the cellulose esters, it is preferable to use cellulose acylates. Since the cellulose acylates are used widely in the industrial field, it is advantageous in terms of the accessibility convenience.

As the cellulose acylates, lower fatty acid esters having 2 to 4 carbon atoms are preferable. The lower fatty acid ester may be one including a single lower fatty acid ester such as a cellulose acetate, or it may be one including a plurality of fatty acid esters such as a cellulose acetate butylate and a cellulose acetate propionate.

In the present invention, among the above-mentioned lower fatty acid esters, a cellulose acetate can be used particularly preferably. As the cellulose acetate, it is preferable to use a triacetyl cellulose having the average a certification degree of 57.5 to 62.5% (substitution degree: 2.6 to 3.0). Since the a certification degree is in the range, the triacetyl cellulose can be provided with the further superior optical isotropy. Here, the above-mentioned a certification degree denotes the bonded acetic acid amount per cellulose unit mass, and it can be obtained by the measurement and the calculation of the acetylation degree in the ASTM: D-817-91 (testing method for the cellulose acetate, or the like).

The content of the resin in the solid component of the retardation layer forming coating solution of the present invention is not particularly limited as long as the mechanical strength of the retardation layer to be formed using the retardation layer forming coating solution of the present invention can be provided in a desired range. In particular, in the present invention, it is preferably in the range of 3% by mass to 15% by mass, it is more preferably in the range of 3% by mass to 12% by mass, and it is particularly preferably in the range of 3% by mass to 10% by mass. In the case the content of the resin is less than the above-mentioned range, due to the deterioration of the alignment property of the rodlike compound, the retardation layer to be formed using the retardation layer forming coating solution of the present invention may not be provided with the desired optical characteristics. Moreover, in the case of forming a retardation layer on a substrate using the retardation layer forming coating solution of the present invention, the adhesion property of the substrate and the retardation layer may be deteriorated. On the other hand, in the case the content of the resin is more than the above-mentioned range, the retardation layer to be formed using the retardation layer forming coating solution of the present invention may not be provided with the desired optical property.

3. Solvent

Next, the solvent used in the present invention will be explained. The solvent used in the present invention is not particularly limited as long as it can dissolve the rodlike compound and the resin to a desired concentration. In the present invention, the solvent may be used by only one kind or as a solvent mixture of two or more kinds.

As the solvent used in the present invention, it is preferable to use those not dissolving the above-mentioned substrate according to the kind of the substrate for forming the retardation layer using the retardation layer forming coating solution of the present invention.

As the solvent used in the present invention, for example, hydrocarbon based solvents such as benzene and hexane: ketone based solvents such as methyl ethyl ketone, methyl isobutyl ketone and cyclohexanone; ether based solvents such as tetrahydrofuran and 1,2-dimethoxyethane; halogenated alkyl based solvents such as chloroform and dichloromethane; ester based solvents such as methyl acetate, ethyl acetate, butyl acetate and propylene glycol monomethyl ether acetate; amide based solvents such as N,N-dimethyl formamide; sulfoxide based solvents such as dimethyl sulfoxide; an one based solvents such as cyclohexane; or alcohol based solvents such as methanol, ethanol and propanol can be presented, however, it is not limited thereto.

4. Retardation Layer Forming Coating Solution

In the present invention, configurations other than the above-mentioned rodlike compound, resin and solvent may be included. As the other configurations used in the present invention, for example, a polymerization initiating agent or a polymerization inhibiting agent can be presented.

As the polymerization initiating agent, for example, benzophenone, a o-benzoyl methyl benzoate, 4,4-bis (dimethyl amine) benzophenone, 4,4-bis(diethyl amine) benzophenone, α-amino-acetophenone, 4,4-dichlorobenzophenone, 4-benzoyl-4-methyl diphenyl ketone, dibenzyl ketone, fluolenone, 2,2-diethoxy acetophenone, 2,2-dimethoxy-2-phenyl acetophenone, 2-hydroxy-2-methyl propiophenone, p-tert-butyl dichloroacetophenone, thioxantone, 2-methyl thioxantone, 2-chlorothioxantone, 2-isopropyl thioxantone, diethyl thioxantone, benzyl dimethyl ketal, benzyl methoxy ethyl acetal, benzoin methyl ether, benzoin butyl ether, anthraquinone, 2-tert-butyl anthraquinone, 2-amyl anthraquinone, β-chloranthraquinone, anthrone, benzanthrone, dibenzsuberone, methylene anthrone, 4-adidobenzyl acetophenone, 2,6-bis(p-adidobendilidene)cyclohexane, 2,6-bis(p-adidobendilidene)-4-methyl cyclohexanone, 2-phenyl-1,2-butadion-2-(o-methoxy carbonyl) oxime, 1-phenyl-propane dion-2-(o-ethoxy carbonyl) oxime, 1,3-diphenyl-propane trion-2-(o-ethoxy carbonyl) oxime, 1-phenyl 3-ethoxy-propane trion-2-(o-benzoyl) oxime, Michler's ketone, 2-methyl-1[4-(methyl thio)phenyl]-2-morpholino propane-1-on, 2-benzyl-2-dimethyl amino-1-(4-morpholino phenyl)-butanone, naphthalene sulfonyl chloride, quinoline sulfonyl chloride, n-phenyl thioacrydone, 4,4-azo bis isobuthylonitrile, diphenyl disulfide, benzthiazol disulfide, triphenyl phosphine, camphor quinine, N1717 produced by Asahi Denka Co., Ltd., carbon tetrabromate, tribromo phenyl sulfone, benzoin peroxide, eosin, or a combination of a photo reducing pigment such as a methylene blue and a reducing agent such as ascorbic acid and triethanol amine can be presented as an example. In the present invention, these photo polymerization initiating agents can be used only by one kind or as a combination of two or more kinds.

Furthermore, in the case of using the photo polymerization initiating agent, a photo polymerization initiating auxiliary agent can be used in combination. As such a photo polymerization initiating auxiliary agent, tertiary amines such as triethanol amine, and methyl diethanol amine; benzoic acid derivatives such as 2-dimethyl aminoethyl benzoic acid and 4-dimethyl amide ethyl benzoate, or the like can be presented, however, it is not limited thereto.

As the polymerization inhibiting agent, for example, diphenyl pycryl hydrazide, tri-p-nitrophenyl methyl, p-benzoquinone, p-tert-butyl catechol, picric acid, copper chloride, methyl hydroquinone, methoquinone, or tert-butyl hydroquionone can be used. In particular, in terms of the storage stability, a hydroquinone based polymerization initiating agent is preferable, and it is particularly preferable to use methyl hydroquinone.

In the retardation layer forming coating solution of the present invention, the following compounds may be added in the range not to deteriorate the purpose of the present invention. As the compound to be added, for example, polyester (meth)acrylate obtained by reacting (meth)acrylic acid with a polyester prepolymer obtained by condensation of a polyhydric alcohol and a monobasic acid or a polybasic acid; polyurethane (meth)acrylate obtained by reacting a polyol group and a compound having two isocyanate groups, and reacting the reaction product with (meth)acrylic acid; a photo polymerizable compound such as epoxy (meth)acrylate obtained by reacting (meth) acrylic acid with epoxy resins such as bisphenol A type epoxy resin, bisphenol F type epoxy resin, novolak type epoxy resin, polycarboxylic acid glycidyl ester, polyol glycidyl ether, aliphatic or alicyclic epoxy resin, amino group epoxy resin, triphenol methane type epoxy resin, and dihydroxy benzene type epoxy resin; or a photo polymerizable liquid crystalline compound having an acrylic group or a methacrylic group can be presented. The addition amount of these compounds with respect to the retardation layer forming coating solution can be determined in the range not to deteriorate the purpose of the present invention. Since the compounds mentioned above are added, the mechanical strength of the retardation layer to be formed using the retardation layer forming coating solution of the present invention can be improved so that the stability may be improved.

Furthermore, the retardation layer forming coating solution of the present invention may further include a leveling agent, a silane coupling agent, or the like in addition to the compounds mentioned above.

The solid component content of the retardation layer forming coating solution of the present invention is not particularly limited as long as the viscosity of the retardation layer forming coating solution of the present invention can be provided in a desired range. It is in general in the range of 5% by mass to 30% by mass; it is more preferably in the range of 5% by mass to 25% by mass; and it is particularly preferably in the range of 5% by mass to 20% by mass.

Here, the solid component content can be measured by for example, the heated-air drying weight measurement method.

5. Manufacturing Method of a Retardation Layer Forming Coating Solution

The manufacturing method of a retardation layer forming coating solution of the present invention is not particularly limited as long as it is a method capable of manufacturing an optical functional layer forming composition having the above-mentioned configuration, and thus a method commonly used as a manufacturing method of an organic solvent based coating solution can be employed. As a specific method, a method of dissolving the above-mentioned rodlike compound and the resin, or the like in the solvent each by a predetermined concentration can be presented. In such a method, as to the order of dissolving the above-mentioned rodlike compound and the above-mentioned resin, the rodlike compound may be dissolved earlier, the resin may be dissolved earlier, or these may be dissolved at the same time.

6. Application of the Retardation Layer Forming Coating Solution

The application of the retardation layer forming coating solution of the present invention is not particularly limited as long as it is the application for the purpose of forming a retardation layer having the minus C property. In particular, it can be used preferably for forming a retardation layer for providing an optical compensator to be used for a liquid crystal display. In particular, since the retardation layer forming coating solution of the present invention can form a retardation layer having the minus C property on an optional substrate, it can be used preferably for forming a retardation layer of a viewing angle compensator for a VA system liquid crystal display. Moreover, it can be used also for the application of forming a retardation film having both the A property and the minus C property by forming a minus C property retardation layer on an optical substrate having the property optically as an A plate (hereinafter, it may be referred to simply as the “A property”).

B. Retardation Optical Product

Next, the retardation optical product of the present invention will be explained. The retardation optical product of the invention comprises an optical substrate and a retardation layer formed on the optical substrate, wherein the retardation layer includes a resin having the optical isotropy and a rodlike compound having the refractive index anisotropy and shows the property as the optically negative C plate.

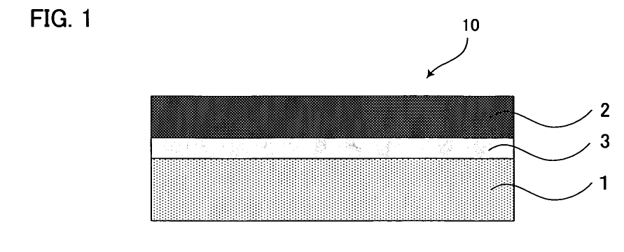

The retardation optical product of the present invention will be explained with reference to the drawings. FIG. 1 is a schematic cross-sectional view showing an example of a retardation optical product of the present invention. As shown in FIG. 1, the retardation optical product 10 of the present invention comprises a retardation layer 2 formed on an optical substrate 1, and a hard coat layer 3 provided between the d optical substrate 1 and the retardation layer 2. Moreover, according to the retardation optical product 10 of the present invention, the retardation layer 2 includes the resin having the optical isotropy and the rodlike compound having the refractive index anisotropy so as to show the property as the optically negative C plate.

According to the retardation optical product of the present invention, since the retardation layer includes the resin having the optical isotropy and the rodlike compound having the refractive index anisotropy so as to show the property as the optically negative C plate, regardless of the kind of the optical substrate, a retardation optical product having the property as the optically negative C plate can be obtained. Moreover, since the resin is included in the retardation layer, a retardation optical product having the excellent adhesion property between the substrate and the retardation layer can be obtained.

The retardation optical product of the present invention comprises an optical substrate and a retardation layer. Hereinafter, each configuration of the retardation optical product of the present invention will be explained in detail.

1. Retardation Layer

First, the retardation layer in the retardation optical product of the present invention will be explained. The retardation layer used in the present invention includes the resin having the optical isotropy and the rodlike compound showing a refractive index anisotropy so as to show the property as the optically negative C plate.

(1) Rodlike Compound Having the Refractive Index Anisotropy

First, the rodlike compound having the refractive index anisotropy used in the present invention will be explained. The content of the rodlike compound contained in the retardation layer is not particularly limited as long as it is in the range capable of providing a retardation layer with a desired minus C property. In particular, in the present invention, it is preferable that the content of the rodlike compound is in the range of 10 parts by weight to 200 parts by weight with respect to 100 parts by weight of the resin having the optical isotropy to be described later; it is more preferably in the range of 30 parts by weight to 170 parts by weight; and it is particularly preferably in the range of 30 parts by weight to 150 parts by weight. In the case the content of the rodlike compound is less than the above-mentioned range, a desired minus C property may not be provided to a retardation layer. Moreover, in the case it is more than the above-mentioned range, depending on the kind of the rodlike compound, the mechanical strength of the retardation layer formed may not be provided in a predetermined range.

The rodlike compound used in the present invention may be used by only one kind, or as a mixture of two or more kinds. Since the rodlike compound used in the present invention is same as the content explained in the above-mentioned item of “A. Retardation layer forming coating solution”, the explanation thereof is omitted here.

(2) Resin having the Optical Isotropy

The resin having the optical isotropy included in the retardation layer of the present invention will be explained. The content of the resin in the retardation layer of the present invention is not particularly limited as long as the mechanical strength of the retardation layer is provided in a desired range. In particular, in the present invention, it is preferably in the range of 20% by mass to 90% by mass; it is more preferably in the range of 30% by mass to 80% by mass; and it is particularly preferably in the range of 40% by mass to 70% by mass. In the case the content of the resin is less than the above-mentioned range, due to the deterioration of the alignment property of the rodlike compound, the desired optical characteristics may not be provided to the retardation layer. Moreover, the adhesion property of the optical substrate to be described later and the retardation layer may be lowered. On the other hand, in the case the content of the resin is more than the above-mentioned range, a retardation layer having the excellent flat surface property may hardly be formed.

The resin used in the present invention may be used by only one kind, or as a mixture of two or more kinds. Since the resin used in the present invention is same as the content explained in the above-mentioned item of “A. Retardation layer forming coating solution”, the explanation thereof is omitted here.

(3) Retardation Layer

The retardation layer in the retardation optical product of the present invention has the property as the optically negative C plate (minus C property). Here, the retardation layer in the retardation optical product of the present invention “has the property as the optically negative C plate (minus C property)” denotes that the retardation in the thickness direction of the retardation layer (hereinafter, it may be referred to as “Rth”) is 10 nm or more. Since the definition of Rth in the present invention is same as the content explained in the above-mentioned item of “A. Retardation layer forming coating solution”, the explanation thereof is omitted here.

As to the method for measuring the Rth of the retardation layer in the present invention, for example, it can be calculated by each measuring the Rth of the retardation optical product of the present invention and that of the one without the retardation layer from the retardation optical product of the present invention, and subtracting the Rth of the latter from the Rth of the former. As the method for removing the retardation layer from the retardation optical product of the present invention, for example, a method of physically removing by cutting and a method of chemically removing by dissolving with a solvent can be presented. Moreover, in the case the substrate and the other layers comprising the retardation optical product of the present invention can be specified and prepared separately, the Rth of the retardation layer in the present invention can also be calculated by subtracting the Rth of the substrate and the other layers measured separately from the Rth of the retardation optical product of the present invention. The value of the Rth can be measured with an automatic birefringence measurement device (produced by Oji Scientific Instruments, product name: KOBRA-21ADH).

The Rth of the retardation layer in the present invention shows 10 nm or more as mentioned above. In the present invention, it is preferably in the range of 50 nm to 400 nm; it is more preferably in the range of 100 nm to 300 nm; and it is particularly preferably in the range of 100 nm to 200 nm.

Moreover, in the retardation layer of the present invention, it is preferable that the value (Rth/d) obtained by dividing the Rth (nm) by the thickness of the retardation layer (d (μm)) is in the range of 0.5 to 13; it is more preferably in the range of 0.5 to 10; and it is particularly preferably in the range of 0.5 to 7.

Moreover, the wavelength dispersion of the Rth of the retardation layer of the present invention may be any wavelength dispersion of the normal dispersion type, the flat type and the inverse dispersion type. In particular, in the present invention, it is preferable that the Rth of the retardation layer shows a wavelength dispersion of the normal dispersion type. Here, the normal dispersion denotes one having the wavelength dependency of the Rth with the tendency to increase according to shortening of the measurement wavelength of the Rth. Contrary to the normal dispersion, the inverse dispersion denotes one having the wavelength tendency of the Rth with the tendency to reduce according to shortening of the measurement wavelength of the Rth. Moreover, the flat type denotes one having the tendency with the wavelength dependenvy of the Rth not to be changed by the measurement wavelength of the Rth.

The in-plane retardation (hereinafter, it may be referred to as “Re”) of the retardation layer in the present invention is preferably in the range of 0 nm to 5 nm; it is more preferably in the range of 0 nm to 3 nm; and it is particularly preferably in the range of 0 nm to 1 nm. Since Re is in the range, the retardation layer in the present invention may be provided with the excellent minus C property realizing property. Here, the Re is the value represented by the formula of Re=(Nx−Ny)×d, with the refractive index Nx in the leading phase axis direction (the direction with the smallest refractive index) in the plane of the retardation layer, the refractive index Ny in the lagging phase axis direction (the direction with the largest refractive index), and the thickness “d” of the retardation film. Since the method for measuring the Re of the retardation layer is same as the method for measuring the Rth of the retardation layer mentioned above, the explanation thereof is omitted here. Re in the present invention denotes the value at a 589 nm wavelength unless otherwise specified.

Moreover, in the retardation layer in the present invention, it is preferable that the value (Re/d) obtained by dividing the Re (nm) by the thickness of the retardation layer (d (μm)) is in the range of 0 to 0.2; it is more preferably in the range of 0 to 0.1; and it is particularly preferably in the range of 0 to 0.05.

The haze of the retardation layer in the present invention is in the range of 0% to 5%; it is more preferably in the range of 0% to 1%; and it is particularly preferably in the range of 0% to 0.5%. As to the method for measuring the haze of the retardation layer in the present invention, for example, it can be calculated by each measuring the haze of the retardation optical product of the present invention and that of the one without the retardation layer from the retardation optical product of the present invention, and subtracting the haze value of the latter from the haze value of the former. As the method for removing the retardation layer from the retardation optical product of the present invention, for example, a method of physically removing by cutting and a method of chemically removing by dissolving with a solvent can be presented. Moreover, in the case the substrate and the other layers comprising the retardation optical product of the present invention can be specified and prepared separately, the Rth of the retardation layer in the present invention can also be calculated by subtracting the haze of the substrate and the other layers measured separately from the haze of the retardation optical product of the present invention. As the haze, the value measured based on the JIS K7105 is used.

Moreover, in the present invention, it is preferable that the above-mentioned retardation layer does not have a selective reflection wavelength. In the present invention, the retardation layer “does not have a selective reflection wavelength” is synonymous with that the rodlike compound does not form a cholesteric sequence in the retardation layer of the present invention. In the case the rodlike compound forms a cholesteric sequence, an alignment film is required in many cases. However, such an alignment film is disadvantageous in that the adhesion property with the optical substrate is poor. Therefore, since the cholesteric sequence is not formed, the adhesion property of the retardation layer and the optical substrate to be described later can be improved in the retardation optical product of the present invention. The fact that the retardation layer in the present invention does not have a selective reflection wavelength can be evaluated with for example a ultraviolet visible and near infrared spectrophotometer produced by Shimadzu Corporation (UV-3100, or the like).

The thickness of the retardation layer in the present invention is not particularly limited as long as it is in the range capable of providing a desired minus C property to the retardation layer according to the kind of the rodlike compound. In particular, in the present invention, it is preferable that the thickness of the retardation layer is in the range of 0.5 μm to 10 μm; it is more preferably in the range of 0.5 μm to 5 μm; and it is particularly preferably in the range of 1 μm to 3 μm. Here, in the retardation optical product of the present invention, in the case the bonding portion of the retardation layer and the optical substrate to be described later has a mixed region with themselves “mixed”, the thickness of the above-mentioned mixed region is not included in the thickness of the retardation layer.

The configuration of the retardation layer in the present invention is not limited to the configuration comprising a single layer, and it may have a configuration with a plurality of layers laminated. In the case of a configuration with a plurality of layers laminated, layers of the same composition may be laminated, or a plurality of layers having different compositions may be laminated.

2. Optical Substrate

Next, the optical substrate used in the retardation optical product of the present invention will be explained. The optical substrate used in the present invention is not particularly limited as long as it has an optical property capable of providing desired optical characteristics to the retardation optical product of the present invention according to the application of the retardation optical product of the present invention, or the like. As the above-mentioned optical property, for example, the linear polarization property of transmitting only a light beam in a specific oscillation direction; the refraction property of refracting a light beam; the birefringence property showing a plurality of different refractive indices in the planar or thickness direction (circular polarization property, elliptical polarization property) and the optical isotropy without a birefringence index can be presented. “Without a birefringence index” mentioned above denotes that the Re of the optical substrate is in the range of 0 nm to 30 nm, and the Rth is in the range of 0 nm to 10 nm. Moreover, the optical substrate used in the present invention may have the light transmitting property of simply transmitting a light beam.

It is preferable that the optical substrate used in the present invention has the property as the optical A plate (A property). Since the substrate has the A property, the retardation optical product of the present invention can have both the minus C property and the A property at the same time so that in the case of using the retardation optical product is used as an optical compensator for a liquid crystal display, it can contribute to provide the liquid crystal display in a thin shape, and thus it is advantageous.

In the present invention, “to have the property as the optical A plate” mentioned above denotes that the Re of the optical substrate is 30 nm or more. In the present invention, it is preferably in the range of 30 nm to 250 nm; it is more preferably in the range of 30 nm to 200 nm; and it is particularly preferably in the range of 30 nm to 150 nm. Here, since the definition and the measurement method of the Re are same as the content explained in the item of “1. Retardation layer”, the explanation thereof is omitted here.

The Rth of the optical substrate used in the present invention can be determined optionally in consideration to the minus C property of the retardation layer, or the like according to the degree of the minus C property to be provided to the retardation optical product of the present invention. In particular, in the present invention, it is preferable that the Rth of the optical substrate is in the range of 20 nm to 100 nm; it is more preferably in the range of 25 nm to 80 nm; and it is particularly preferably in the range of 30 nm to 60 nm. Since the definition and the measurement method of the Rth are same as the content explained in the item of “A. Retardation layer forming coating solution” mentioned above, the explanation thereof is omitted here.

The wavelength dispersion of the Rth of the optical substrate may be of any embodiment of the normal dispersion type, the flat type and the inverse dispersion type. In particular, in the present invention, it is preferable that the Rth of the substrate shows a wavelength dispersion of the normal dispersion type or the flat type, and it is particularly preferable to show the wavelength dispersion of the flat type.

The transparency of the optical substrate used in the present invention may be determined optionally according to the transparency required to the retardation optical product of the present invention, or the like. In general, it is preferable that the transmittance in a visible light range is 80% or more, and it is more preferably 90% or more. Here, the transmittance of the substrate can be measured according to the JIS K7361-1 (Testing method of the total light transmittance of a plastic-transparent material).

The thickness of the optical substrate used in the present invention is not particularly limited as long as a necessary self supporting property can be obtained according to the application of the retardation optical product of the present invention, or the like. In general, it is preferably in the range of 10 μm to 188 μm; it is more preferably in the range of 20 μm to 125 μm; and it is particularly preferably in the range of 30 μm to 80 μm. In the case the thickness of the optical substrate is thinner than the above-mentioned range, the necessary self supporting property may not be provided to the retardation optical product of the present invention. Moreover, in the case the thickness is thicker than the above-mentioned range, for example, at the time of cutting process of the retardation optical product of the present invention, the process waste may be increased or wear of the cutting blade may be promoted.

Here, in the retardation optical product of the present invention, in the case the bonding portion of the retardation layer and the optical substrate has a mixed region with themselves “mixed”, the thickness of the optical substrate includes the thickness of the above-mentioned mixed region.

As the optical substrate used in the present invention, either a flexible material having the flexible property or a rigid material without the flexible property can be used as long as it has a desired optical property, however, it is preferable to use a flexible material. Since the flexible material is used, the production process for the retardation optical product of the present invention can be provided as a roll-to-roll process so that a retardation optical product having the excellent productivity can be obtained.

As the material for the above-mentioned flexible material, a cellulose derivative, a norbornen based polymer, a cycloolefin based polymer, polymethyl methacrylate, polyvinyl alcohol, polyimide, polyallylate, a polyethylene terephthalate, polysulfone, polyether sulfone, amorphous polyolefin, a modified acrylic based polymer, polystyrene, epoxy resin, polycarbonate, polyesters, or the like can be presented. In the present invention, a cellulose derivative and a norbornen based polymer can be used preferably.

In particular, in the present invention, it is preferable to use a norbornen based polymer. Moreover, as the norbornen based polymer, a cycloolefin polymer (COP) and a cycloolefin copolymer (COC) can be presented. In the present invention, it is preferable to use a cycloolefin polymer. Since the cycloolefin polymer has low absorbing property and transmitting property of the moisture content, by using the optical substrate used in the present invention made of the cycloolefin polymer, the retardation optical product of the present invention can be provided with the excellent aging stability of the optical characteristics.

As a specific example of the cycloolefin polymer used in the present invention, product name: ARTON produced by JSR Corporation can be presented.

A drawing treatment may be applied to the optical substrate used in the present invention. As such a drawing treatment, a uniaxial drawing treatment and a biaxial treatment process can be presented.

The configuration of the optical substrate in the present invention is not limited to the configuration comprising a single layer, and a configuration with a plurality of layers laminated may be employed. In the case of the configuration with a plurality of layers laminated, layers of the same composition may be laminated, or a plurality of layers having different compositions may be laminated. As the configuration with a plurality of layers laminated, for example, one comprising a polarizer having the linear polarization property and a resin film made of the above-mentioned material can be presented.

3. Retardation Optical Product

The retardation optical product of the present invention may have other configurations other than the above-mentioned retardation layer and the above-mentioned optical substrate. As the other configurations, for example, a hard coat layer, a reflection preventing layer, a ultraviolet ray absorbing layer, an infrared ray absorbing layer, or a charge preventing layer can be presented.

In the present invention, as the above-mentioned other configurations, it is preferable to have a hard coat layer, and it is particularly preferable to have the hard coat layer between the optical substrate and the retardation layer. Since the retardation optical product of the present invention has a hard coat layer by such an embodiment, the adhesion property of the retardation layer and the optical substrate can be improved. Moreover, since the hard coat layer is provided by the above-mentioned embodiment, for example, in the case of manufacturing a retardation optical product by applying the retardation layer forming coating solution on the optical substrate, erosion of the optical substrate by the solvent included in the retardation layer forming coating solution can be prevented.

As the material used for the hard coat layer used in the present invention, for example, polyester (meth)acrylate obtained by reacting (meth)acrylic acid with a polyester prepolymer obtained by condensation of a polyhydric alcohol and a monobasic acid or a polybasic acid; polyurethane (meth)acrylate obtained by reacting a polyol group and a compound having two isocyanate groups, and reacting the reaction product with (meth)acrylic acid; a photopolymerizable compound such as epoxy (meth) acrylate obtained by reacting (meth)acrylic acid with epoxy resins such as bisphenol A type epoxy resin, bisphenol F type epoxy resin, novolak type epoxy resin, polycarboxylic acid glycidyl ester, polyol glycidyl ether, aliphatic or alicyclic epoxy resin, amino group epoxy resin, triphenol methane type epoxy resin, and dihydroxy benzene type epoxy resin; or a photopolymerizable liquid crystalline compound having an acrylic group or a methacrylic group can be presented. In the present invention, these materials may be used by only one kind, or as a mixture of two or more kinds.

The thickness of the hard coat layer used in the present invention is preferably in the range of 1 μm to 30 μm; it is more preferably in the range of 1 μm to 25 μm; and it is particularly preferably in the range of 1 μm to 20 μm.

The reflection preventing layer used in the present invention is not particularly limited. For example, one comprising a low refractive index layer formed on a transparent substrate film, in which the layer made of a substance having a refractive index lower than that of the transparent substrate; or one comprising a high refractive index layer made of a substance having a refractive index higher than that of the transparent substrate and a low refractive index layer made of a substance having a refractive index lower than that of the transparent substrate formed in this order alternately by each one or more layers on a transparent substrate film can be presented. These high refractive index layer and the low refractive index layer are formed such as by vacuum vapor deposition or coating so as to have the optical thickness represented by the multiple of the geometric thickness and the refractive index by ¼ of the wavelength of the light beam to have the reflection prevention. As the constituent material for the high refractive index layer, titanium oxide, zinc sulfide, or the like; as the constituent material for the low refractive index layer, magnesium fluoride, cryolite, or the like can be used.

Moreover, the ultraviolet ray absorbing layer used in the present invention is not particularly limited. For example, a film formed by adding a ultraviolet ray absorbing agent made of such as a benzotriazol based compound, a benzophenone based compound, or a salicylate based compound in a film of such as polyester resin or acrylic resin can be presented.

Moreover, the infrared ray absorbing layer used in the present invention is not particularly limited. For example, one formed by such as coating an infrared ray absorbing layer on a film substrate of polyester resin can be presented. As the infrared ray absorbing layer, for example, one formed by adding an infrared ray absorbing agent made of such as a diimmonium based compound or a phthalocyanine based compound in a binder resin made of such as acrylic resin or polyester resin can be used.

Moreover, as the charge preventing layer used in the present invention, for example, various kinds of cation charge preventing agents having a cation group such as quaternary ammonium salt, pyridinium salt, and primary to tertiary amino salts; anion charge preventing agents having an anion group such as a sulfonic acid base, an ester sulfide base, an ester phosphate base, and a phosphoric acid base; amphoteric charge preventing agents of such as the amino acid based, and the amino ester sulfide based; nonion charge preventing agents of such as the amino alcohol based, the glycerol based, and the polyethylene glycol based; polymer type charge preventing agents with the above-mentioned charge preventing agents provided with a high molecular weight; those formed as a film by adding a charge preventing agent such as a monomer or an oligonomer having a tertiary amino group or a quaternary ammonium group and to be polymerized by the ionizing radiation, such as N,N-dialkyl amino alkyl (meth)acrylate monomer and a quaternary compound thereto can be presented.

The Rth of the retardation optical product of the present invention may be selected optionally according to such as the application of the retardation optical product of the present invention, and thus it is not particularly limited. In particular, in the present invention, it is preferable that the Rth is in the range of 60 nm to 450 nm; it is more preferably in the range of 70 nm to 400 nm; and it is particularly preferably in the range of 80 nm to 350 nm. Since the Rth is in the above-mentioned range, the retardation optical product of the present invention can be used preferably for improving the viewing angle dependency of a liquid crystal display of the VA (vertical alignment) system.

Moreover, the Re of the retardation optical product of the present invention can be selected optionally according to such as the application of the retardation optical product of the present invention, and thus it is not particularly limited. In particular, in the present invention, it is preferable that the Re is in the range of 20 nm to 150 nm; it is more preferably in the range of 30 nm to 130 nm; and it is particularly preferably in the range of 40 nm to 110 nm. Since the Re is in the above-mentioned range, the retardation optical product of the present invention can be used preferably for improving the viewing angle dependency of a liquid crystal display of the VA (vertical alignment) system.

The thickness of the retardation optical product of the present invention is not particularly limited as long as it is in the range capable of realizing a desired optical characteristic. In general, it is preferably in the range of 20 μm to 150 μm; it is more preferably in the range of 25 μm to 130 μm; and it is particularly preferably in the range of 30 μm to 110 μm.

Moreover, in the retardation optical product of the present invention, it is preferable that the haze value measured based on the JIS K7105 is in the range of 0% to 2%; it is more preferably in the range of 0% to 1.5%; and it is particularly preferably in the range of 0% to 1%.

4. Manufacturing Method of a Retardation Optical Product

The manufacturing method of a retardation optical product of the present invention is not particularly limited as long as it is a method for forming a homogeneous retardation layer on the above-mentioned optical substrate, and the method to be explained in the item of “C. Manufacturing method of g a retardation optical product” to be described later can be used.

5. Application of the Retardation Optical Product

As the application of the retardation optical product of the present invention, for example, an optical compensator (for example, a viewing angle compensator), an elliptical polarizing plate, or a luminance improving plate can be presented. In particular, the retardation optical product of the present invention can be used preferably as an optical compensator for improving the viewing angle dependency of a liquid crystal display. Furthermore, since the retardation optical product of the present invention comprises the retardation layer having the minus C property, it can be used most preferably as an optical compensator for a liquid crystal display of the VA system.

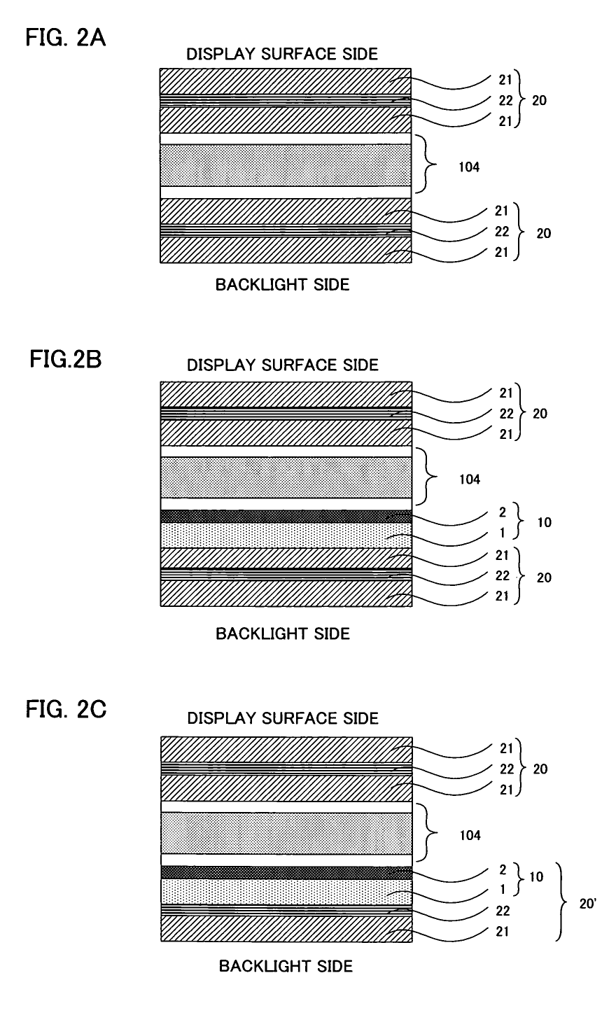

As the embodiment of using the retardation optical product of the present invention as an optical compensator for a liquid crystal display, it is not particularly limited as long as it is an embodiment capable of obtaining a desired viewing angle characteristic. The embodiment of using the retardation optical product of the present invention as an optical compensator for a liquid crystal display will be explained specifically with reference to the drawings. FIGS. 2A to 2C are each a schematic diagram for explaining the embodiment of using the retardation optical product of the present invention as an optical compensator for a liquid crystal display. FIG. 2A is a schematic cross-sectional view showing an example of a common liquid crystal display without the retardation optical product of the present invention. As shown in FIG. 2A, the common liquid crystal display has a configuration with a liquid crystal cell 104 sandwiched by two polarizing plates 20. The polarizing plates 20 are formed by laminating a polarizing plate protection film 21 on the both surfaces of a polarizer 22.

FIG. 2B is a schematic cross-sectional view showing an example of a liquid crystal display using a retardation optical product of the present invention. As shown in FIG. 2B, as for an embodiment of using the retardation optical product of the present invention as an optical compensator, an embodiment of laminating the retardation optical product 10 of the present invention between the liquid crystal cell 104 and the backlight side polarizing plate can be presented. According to the embodiment, it is advantageous in that the members used for the conventional liquid crystal display can be used as they are.

FIG. 2C is a schematic cross-sectional view showing other example of a liquid crystal display using a retardation optical product of the present invention. As shown in FIG. 2C, as for an embodiment of using the retardation optical product of the present invention as an optical compensator, an embodiment of using the retardation optical product 10 of the present invention instead of a polarizing plate protection film comprising the backlight side polarizing plate 20′ can be presented. According to this embodiment, since the retardation optical product of the present invention provides the function as an optical compensator for improving the viewing angle dependency and the function as a polarizing plate protection film, the liquid crystal display can be provided in a further thin shape.

Moreover, the retardation optical product of the present invention can also be used as a polarizing film by utilizing a polarizing plate having a linear polarization property as the above-mentioned optical substrate.

C. Manufacturing Method of a Retardation Optical Product

Next, the manufacturing method of a retardation optical product of the present invention will be explained. The manufacturing method of a retardation optical product of the present invention comprises a retardation layer forming process of forming a retardation layer showing the property as the optically negative C plate on an optical substrate by applying a retardation layer forming coating solution, wherein the retardation layer forming coating solution is the retardation layer forming coating solution explained in the above-mentioned item of “A. Retardation layer forming coating solution”.

According to the present invention, since the retardation layer forming coating solution is the retardation layer forming coating solution explained in the above-mentioned item of “A. Retardation layer forming coating solution”, a retardation layer optical product having the property as the optically negative C plate can be manufactured on an optional optical substrate.

The manufacturing method of a retardation optical product of the present invention comprises a retardation layer forming process of forming a retardation layer showing the property as the optically negative C plate on an optical substrate by applying a retardation layer forming coating solution. Hereinafter, the manufacturing method of a retardation optical product of the present invention will be explained in detail. Since the above-mentioned “retardation layer forming coating solution” and the above-mentioned “optical substrate” used in the present invention are same as the content each explained in the above-mentioned item of “A. Retardation layer forming coating solution” and the above-mentioned item of “B. Retardation optical product”, the explanation thereof is omitted here.

1. Retardation Layer Forming Process

The retardation layer forming process in the present invention will be explained. As the applying method for applying the retardation layer forming coating solution onto the optical substrate in the retardation layer forming process in the present invention is not particularly limited as long as it is a method capable of achieving a desired flat surface property according to such as the viscosity or the coating amount of the retardation layer forming coating solution. As the method, for example, the gravure coating method, the reverse coating method, the knife coating method, the dip coating method, the spray coating method, the air knife coating method, the spin coating method, the roll coating method, the printing method, the dipping and pulling up method, the curtain coating method, the die coating method, the casting method, the bar coating method, the extrusion coating method, or the E type applying method can be presented. In particular, in the present invention, the reverse coating method, the die coating method, the spin coating method and the bar coating method can be used preferably.

The thickness of the coated film of the retardation layer forming coating solution is not particularly limited as long as it is in the range capable of achieving a desired flat surface property. In general, it is in the range of 0.1 μm to 50 μm; it is more preferably in the range of 0.5 μm to 30 μm; and it is particularly preferably in the range of 0.5 μm to 10 μm. In the case the thickness of the coated film of the retardation layer forming coating solution is thinner than the above-mentioned range, the flat surface property of the retardation layer to be formed in the retardation layer forming process may be deteriorated. Moreover, in the case the thickness is thicker than the above-mentioned range, due to the increase of the dry load of the solvent, the productivity may be lowered.

As the method for drying the coated film of the retardation layer forming coating solution, a commonly used drying method such as the heat drying method, the pressure reducing drying method, and the gap drying method can be used. Moreover, the drying method in the present invention is not limited to a single method. For example, a plurality of drying methods may be adopted by an embodiment such as of changing the drying methods successively according to the residual solvent amount.

In the case of using a polymerizable material having a polymerizable functional group as the rodlike compound, the method for polymerizing the polymerizable material can be determined optionally according to the kind of the polymerizable functional group of the polymerizable material. In particular, in the present invention, a method of curing the material by the active radiation is preferable. The active radiation is not particularly limited as long as it is a radiation capable of polymerizing the polymerizable material. In general it is preferable to use a ultraviolet ray or a visible light beam in terms of the device convenience, or the like. In particular, it is preferable to use an irradiation beam having a 150 nm to 500 nm wavelength, more preferably 250 nm to 450 nm, and further preferably 300 nm to 400 nm.

As the light source for the irradiation beam, for example a low pressure mercury lamp (a sterilizing lamp, a fluorescent chemical lamp, a black light), a high-pressure discharge lamp (a high pressure mercury lamp, a metal halide lamp), or a short arc discharge lamp (a ultra high pressure mercury lamp, a xenon lamp, a mercury xenon lamp) can be presented. In particular, use of such as the metal halide lamp, the xenon lamp, or the high pressure mercury lamp can be recommended. Moreover, the irradiation can be carried out while optionally adjusting the irradiation intensity according to such as the content of the photo polymerization initiating agent.

2. Others

The manufacturing method of manufacturing a retardation optical product of the present invention may comprise other process other than the above-mentioned retardation layer forming process. As the other process, for example, a hard coat layer forming process, a reflection preventing layer forming process, an ultraviolet ray absorbing layer forming process, an infrared ray absorbing layer forming process, or a charge preventing layer forming process can be presented. In the case the manufacturing method of a retardation optical product of the present invention has the other processes, the time for executing the other processes may be before or after the retardation layer forming process.

Furthermore, the manufacturing method of manufacturing a retardation optical product of the present invention may have a drawing process of drawing the optical substrate with the retardation layer formed after the retardation layer forming process. Since the drawing process is provided, the optical characteristics of the retardation optical product to be produced by the manufacturing method of a retardation optical product of the present invention can be adjusted in a desired range afterwards.

Since the retardation optical product to be produced by the manufacturing method of a retardation optical product of the present invention is same as that mentioned in the above-mentioned item of “B. Retardation optical product”, the explanation thereof is omitted here.

The present invention is not limited to the above-mentioned embodiments. The embodiments are examples and any one having the substantially same configuration as the technological idea disclosed in the claims of the present invention so as to achieve the same effects is incorporated in the technological scope of the present invention.

### EXAMPLES

Hereinafter, the present invention will be explained specifically with reference to the example.

(Retardation Layer Forming Coating Solution)

A retardation layer forming coating solution was prepared by dissolving: as the rodlike compound, 5% by mass of a photo polymerizable liquid crystal compound (the below-mentioned compound (I)); as the resin, 5% by mass of a cellulose acetate (produced by Eastman Chemical Company, product name: CA-398-3); and an optional amount of a photo polymerization initiating agent and a polymerization inhibiting agent in a cyclohexanone. 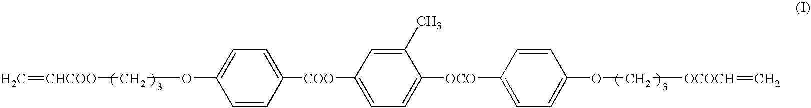
(Hard Coat Layer Forming Coating Solution)

A hard coat layer forming coating solution was prepared by dissolving 20% by mass of PET-30 (produced by NIPPON KAYAKU CO., LTD) and 20% by mass of M-215 (produced by TOAGOSEI CO., LTD.) in a solvent mixture of 30% by mass of a butyl acetate and 30% by mass of MEK.

(Production of a Retardation Film)

The hard coat layer forming coating solution was applied on a uniaxially drawn COP (cycloolefin polymer) film (produced by JSR Corporation, product name: ARTON) by bar coating. Then, by heating at 90° C. for 2 minutes for removing the solvent and directing an ultraviolet ray for curing, a hard coat layer was formed.

Then, the retardation layer forming coating solution was applied on the hard coat layer by bar coating. Then, by heating at 50° C. for 2 minutes, the solvent was eliminated. Furthermore, by directing a ultraviolet ray to the coating surface, the above-mentioned photo polymerizable liquid crystal compound was fixed, and by heating at 90° C. for 2 minutes for removing the remained solvent, a retardation layer was formed. With the obtained retardation film as a sample, it was evaluated for the following items.

<Evaluation>

1. Optical Characteristics

The retardation property of the sample was measured by an automatic birefringence measurement device (produced by Oji Scientific Instruments, product name: KOBRA-21ADH). The anisotropic property of increasing the retardation of the substrate film was confirmed from the chart of the optical retardation and the measurement light beam incident angle at the time of providing a measurement light beam to be incident on the sample surface vertically or obliquely. Moreover, the three-dimensional refractive index was measured by the same measurement device. The results are shown in the following table.

TABLE 1

| | |
|---|---|
| Nx | 1.592 |
| Ny | 1.556 |
| Nz | 1.537 |

2. Haze

For examining the transparency of the sample, the haze value was measured with a turbidity meter (produced by Nippon Denshoku Industries Co., Ltd., product name: NDH2000). As a result, it was 0.5% or less at the time of a 3 g/m² coating amount, and thus it is preferable.

What is claimed is:

1. A retardation layer forming coating solution used for forming a retardation layer showing a property as an optically negative C plate, comprising: a resin having an optical isotropy, a rodlike compound having a refractive index anisotropy, and a solvent for dissolving the resin and the rodlike compound.

2. The retardation layer forming coating solution according to claim 1, wherein a content of the rodlike compound is in the range of 10 parts by weight to 200 parts by weight with respect to 100 parts by weight of the resin.

3. The retardation layer forming coating solution according to claim 1, wherein the rodlike compound has a polymerizable functional group.

4. The retardation layer forming coating solution according to claim 1, wherein the rodlike compound is a liquid crystalline material.

5. The retardation layer forming coating solution according to claim 1, wherein the resin is triacetyl cellulose.

6. A retardation optical product comprising an optical substrate and a retardation layer formed on the optical substrate,
wherein the retardation layer includes a resin having an optical isotropy and a rodlike compound having a refractive index anisotropy, and shows a property as an optically negative C plate.

7. The retardation optical product according to claim 6, wherein a content of the rodlike compound in the retardation layer is in the range of 10 parts by weight to 200 parts by weight with respect to 100 parts by weight of the resin.

8. The retardation optical product according to claim 6, wherein the retardation layer does not have a selective reflection wavelength.

9. The retardation optical product according to claim 6, wherein a hard coat layer is provided between the optical substrate and the retardation layer.

10. The retardation optical product according to claim 6, wherein the optical substrate has a property as an optical A plate.

11. A manufacturing method of a retardation optical product comprising a retardation layer forming process of forming a retardation layer showing a property as an optically negative C plate on an optical substrate by applying a retardation layer forming coating solution, wherein the retardation layer forming coating solution is the retardation layer forming coating solution according to claim 1.
